(19) United States
(12) Patent Application Publication
(10) Pub. No.: US 2025/0202334 A1
(43) Pub. Date: Jun. 19, 2025

(54) ELECTRONIC DEVICE AND METHOD FOR CONTROLLING, WITH OPTIMIZED REGULATION, AN ELECTRICAL ENERGY CONVERTER COMPRISING A RESONATOR, ASSOCIATED ELECTRICAL ENERGY CONVERSION SYSTEM

(71) Applicant: Commissariat à l’Energie Atomique et aux Energies Alternatives, Paris (FR)

(72) Inventors: Lucas Henrique DE ARAUJO PEREIRA, Grenoble Cedex 9 (FR); Ghislain DESPESSE, Grenoble Cedex 9 (FR); Adrien MOREL, Grenoble Cedex 9 (FR); Gaël PILLONNET, Grenoble Cedex 9 (FR)

(73) Assignee: Commissariat à l’Energie Atomique et aux Energies Alternatives, Paris (FR)

(21) Appl. No.: 18/985,748

(22) Filed: Dec. 18, 2024

(30) Foreign Application Priority Data
Dec. 19, 2023 (FR) 2314513

(51) Int. Cl. H02M 1/00; H02M 3/158

(52) U.S. Cl. CPC H02M 1/0025; H02M 3/158

(57) ABSTRACT

This device for controlling a converter including a resonator and several switches, comprises:
a chain for measuring a control variable;
a chain for controlling switching of the switches, in order to alternate phases with substantially constant voltage and substantially constant load at the terminals of the resonator, the control chain comprising a loop for regulating a switching instant of a switch;
a synchronisation module for simultaneously sending a measurement command to the measurement chain and a control command to the control chain,
the time taken for the measurement command to be implemented by the measurement chain is less than the time taken for the control command to be implemented by the control chain, so that the control variable is measured before the switch is switched.

The present invention relates to an electronic device for driving an electrical energy converter capable of converting an input voltage into an output voltage, the converter comprising two input terminals for receiving the input voltage, two output terminals for delivering the output voltage, a resonator, and several switches connected to the resonator.

The invention also relates to an electrical energy conversion system comprising such a converter and such an electronic device for controlling the converter.

The invention also relates to a method of controlling such a converter.

An electronic control device is known, comprising a measurement chain configured to measure a converter regulation variable; a control chain configured to control switching of each of the switches, in order to alternate phases with substantially constant voltage across the resonator and phases with substantially constant load across the said resonator, the control chain comprising a regulation loop configured to regulate, on the basis of the measured regulation variable, a switching instant of a respective switch.

Indeed, strategies for controlling, i.e. driving, DC-DC converters with a six-phase piezoelectric resonator during a resonance cycle, with alternation of phases with a substantially constant voltage at the terminals of the resonator and phases with a substantially constant load at the terminals of the said resonator. However, these strategies use digital control, for example based on a programmable logic device, or circuit, such as an FPGA (Field Programmable Gate Array), which has certain limitations.

The maximum operating frequency of the controlled converters is limited by the sampling frequency and accuracy of the controller, i.e. the control device used or the comparison speed if a comparator is used, for example, to detect the zero crossing of a current or the zero crossing of the voltage derivative and to operate switches directly, as described in the following articles:
J. J. Piel, J. D. Boles, J. H. Lang and D. J. Perreault, “Feedback Control for a Piezoelectric-Resonator-Based DC-DC Power Converter” 2021 IEEE 22nd Workshop on Control and Modelling of Power Electronics (COMPEL);
B. Pollet, G. Despesse and F. Costa, “A New Non-isolated Low-Power Inductorless Piezoelectric DC-DC Converter” in IEEE Transactions on Power Electronics, vol. 34, no. 11; and
M. Touhami, G. Despesse, F. Costa and B. Pollet, “Implementation of Control Strategy for Step-down DC-DC Converter Based on Piezoelectric Resonator” 2020 22nd European Conference on Power Electronics and Applications (EPE'20 ECCE Europe).

Direct control of switches via the control chain from the output of a comparator works up to some 100 kHz, but is no longer possible at a frequency of 10 MHz because of delays internal to the control chain, where the time from sending a control command via the comparator output to the actual switching of the corresponding switch is often longer than the typical duration of the phase concerned

The article by E. A. Stolt, W. D. Braun and J. M. Rivas-Davila, “Forward-Zero Cycle Closed-Loop Control of Piezoelectric Resonator DC-DC Converters” 2022 IEEE 23rd Workshop on Control and Modeling for Power Electronics (COMPEL), describes regulation in step-down voltage mode, maintaining fixed-frequency operation with substantially constant control angles, but short-circuiting the resonator periodically during a complete resonance cycle to adjust the output power of the converter (burst mode). For example, by eliminating one resonance cycle out of five, the output power no longer sees power one resonance period out of five and the energy supplied to the resonator is also reduced, limiting the amplitude of the current in the resonator and therefore the power transmitted over the other four periods. Apart from the stability of the regulation, which is not obvious, this leads to a current in the piezoelectric resonator that is higher than the current strictly necessary when the power demand is lower than the maximum power.

The aim of the invention is therefore to propose an electronic control device, and an associated control method, enabling improved control of the electrical energy converter, particularly for an operating frequency greater than 1 MHz, and typically of the order of 10 MHz.

To this end, the invention relates to an electronic device for controlling an electrical energy converter capable of converting an input voltage into an output voltage, the converter comprising two input terminals to receive the input voltage, two output terminals for delivering the output voltage, a resonator, and several switches connected to the resonator,
the electronic control device comprising:
   a measurement chain configured to measure a control variable of the converter;
a control chain configured to control switching of each of the switches, to alternate phases with substantially constant voltage across the resonator and phases with substantially constant load across said resonator,
the control chain comprising a control loop configured to control a switching time of a respective switch on the basis of the measured control variable;
a synchronisation module configured to simultaneously send a command to measure the control variable to the measurement chain and a command to control the respective switch to the control chain, and
the time taken for the measurement command to be implemented by the measurement chain is less than the time taken for the control command to be implemented by the control chain, so that the control variable is measured before the respective switch is switched.

An error in the control loop can be minimised by measuring the control variable immediately before, i.e. just before, the switch actually switches. Advantageously, the control variable is representative of the voltage across the resonator, and by measuring the control variable just before the respective switch is switched, the error between the measured voltage and the desired constant voltage of the next phase is minimised.

This provides a low-frequency representation of the high-frequency switching error, making it easier to control the converter system at a lower frequency, regardless of the converter's operating speed.

In other beneficial aspects of the invention, the electronic control device comprises one or more of the following features, taken in isolation or in any technically possible combination:
the respective switch is selected from the group comprising:
   one of the switches, referred to as the first switch, connected between one of the input terminals and the resonator, the first switch being switchable between an open position and a closed position in which the input voltage is applied across the resonator;
   one of the switches, referred to as the second switch, connected between one of the input terminals and the resonator, the second switch being switchable between an open position and a closed position in which the voltage is zero across the resonator;
   one of the switches, referred to as the third switch, connected between one of the output terminals and the resonator, the third switch being switchable between an open position and a closed position in which energy from the resonator is restored to the output voltage;
the control variable is selected from the group consisting of: the voltage at the terminals of the resonator; the voltage between one of the terminals of the resonator and a reference potential, such as an electrical earth; the voltage at the terminals of the respective switch; and the voltage between one of the terminals of the respective switch and a reference potential, such as an electrical earth;
the measurement chain comprises two measurement probes adapted to measure the two end potentials of the voltage forming the control variable, each measurement probe being adapted to measure a respective potential at a respective end of said voltage;
the voltage forming the control variable is preferably then obtained by the difference between the two end potentials measured respectively by the two measurement probes;
the measurement chain comprises a sampling module connected to the two measurement probes; the sampling module comprising a first stage connected to the two measurement probes, a second stage connected to the output of the first stage and a differential unit connected to the output of the second stage; the first stage being configured to generate a first sampling pulse, and the second stage being configured to generate a second sampling pulse after the first sampling pulse; the second sampling pulse having a longer duration than the first sampling pulse;
a ratio between the duration of the second sampling pulse and that of the first sampling pulse being preferably greater than 10, even more preferably greater than 15, and even more preferably substantially equal to 20;
the first stage preferably further including a pair of first sampling capacitors and a pair of first switches, each first switch being connected between a respective measurement probe and first capacitor and configured, when switched to the closed position, to enable charging of the respective first capacitor;
the second stage preferably further including a pair of second sampling capacitors and a pair of second switches, each second switch being connected to a respective second capacitor and configured, when switched to the closed position, to enable charging of the respective second capacitor;
when the converter operates at an operating frequency greater than 1 MHz, the control variable is measured between 0.5 ns and 20 ns, advantageously substantially 1 ns, before the respective switch is switched;
the resonator is a piezoelectric resonator;
the piezoelectric resonator preferably consisting of one of the group consisting of: a single piezoelectric element; several piezoelectric elements connected in series; several piezoelectric elements connected in parallel; a piezoelectric element and an auxiliary capacitor connected in series; a piezoelectric element and an auxiliary capacitor connected in parallel; and an arrangement of several parallel branches, each branch comprising one or more piezoelectric elements connected in series or an auxiliary capacitor;
the auxiliary capacitor preferably still having a capacitance greater than, preferably still at least three times, a reference capacitance of the piezoelectric element(s), each piezoelectric element being modelled as a capacitor and a resonant branch connected in parallel with the capacitor, the reference capacitance being the capacitance of said capacitor;
the resonator is an LC resonator comprising an inductor and a capacitor connected in series with the inductor;
an order to measure the control variable is sent simultaneously to the measurement chain and an order to control the respective switch is sent simultaneously to the control chain for several switch controls during the same resonance cycle of the resonator; the duration of implementation of the measurement command by the measurement chain being less than the duration of implementation of the control command by the control chain, so that the control variable is measured before the respective switch is switched, for these several switch commands during the same resonance cycle;
these several switch controls during the same resonance cycle preferably being switch closures forming phase starts with a substantially constant voltage at the resonator terminals;
the control device comprises several control assemblies, and the number of control assemblies is equal to the number of switches whose switching is controlled by the control device, each control assembly comprising a respective synchronisation module, measurement chain and control chain.

The invention also relates to an electrical energy conversion system comprising:
an electrical energy converter capable of converting an input voltage to an output voltage, the converter comprising two input terminals for receiving the input voltage, two output terminals for delivering the output voltage, a resonator, and several switches connected to the resonator; and
an electronic device for controlling the electrical energy converter, the electronic device being as defined above.

The invention also relates to a method of controlling an electrical energy converter capable of converting an input voltage into an output voltage, the converter comprising two input terminals for receiving the input voltage, two output terminals for delivering the output voltage, a resonator, and several switches connected to the resonator,
the method being implemented by an electronic control device and comprising the following steps:
measurement, via a measurement chain, of a converter control variable;
control, via a control chain, of a switching of each of the switches, to alternate phases with substantially constant voltage across the resonator and phases with substantially constant load across said resonator,
the control chain comprising a control loop configured to control a switching time of a respective switch on the basis of the measured control variable;
the method comprising, prior to the measurement and control steps:
synchronisation comprising the simultaneous sending of a command to measure the control variable to the measurement chain and a command to control the respective switch to the control chain, and
the time taken for the measurement command to be implemented by the measurement chain is less than the time taken for the control command to be implemented by the control chain, so that the control variable is measured before the respective switch is switched.

These features and advantages of the invention will appear more clearly upon reading the following description, given solely as a non-limiting example, and made in reference to the attached drawings, in which:

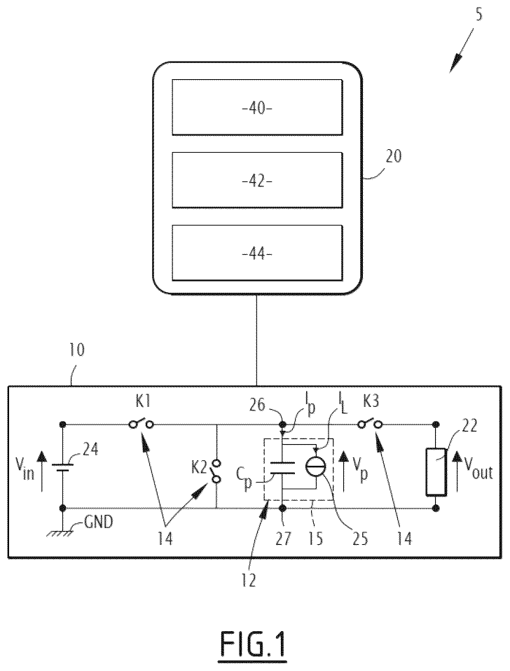

FIG. 1 is a schematic representation of an electronic electrical energy conversion system according to the invention, comprising an electrical energy converter including a resonator and several switches connected to the resonator; and an electronic device for driving the electrical energy converter, the resonator being a piezoelectric resonator;

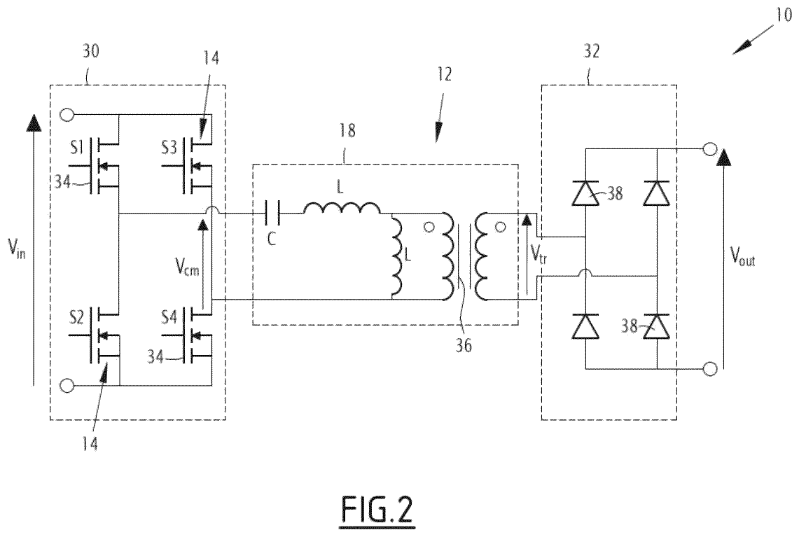

FIG. 2 is a schematic representation of the electrical energy converter when the resonator is an LC resonator;

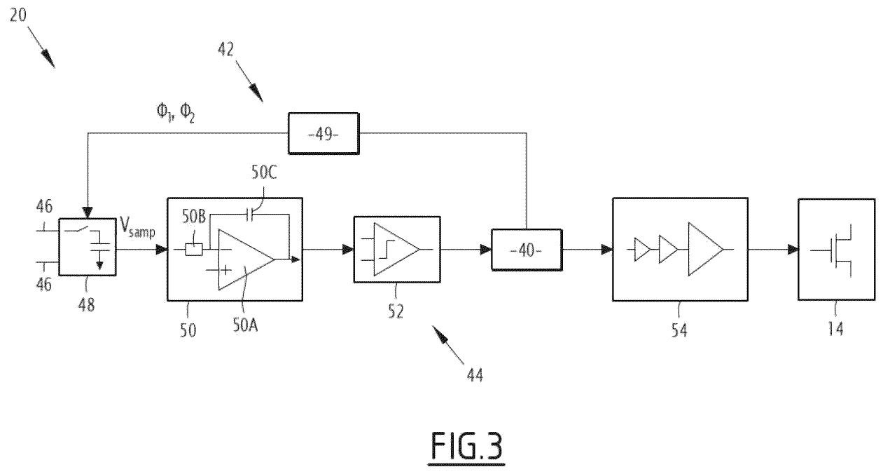

FIG. 3 is a schematic representation of the control device shown in FIG. 1, which comprises a system for measuring a control variable of the converter and a system for controlling the switching of each of the switches;

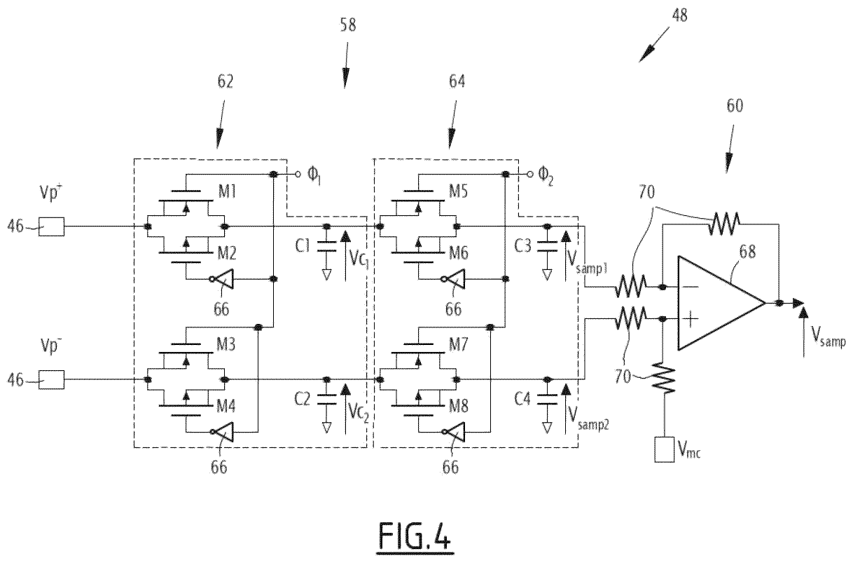

FIG. 4 is a detailed view of a sampling module included in the measurement chain shown in FIG. 3;

FIG. 5 is a flow chart of a method, according to the invention, of controlling an electrical energy converter, the method being implemented by the control device of FIG. 1;

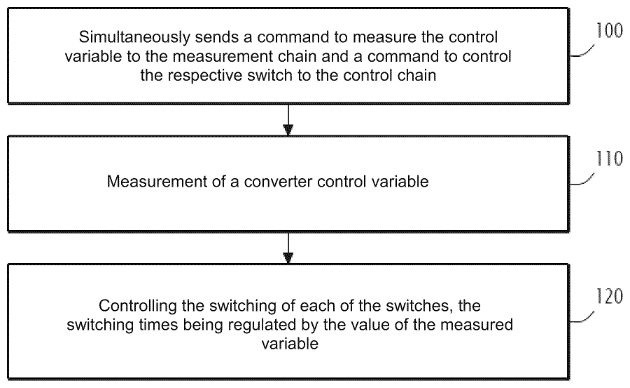

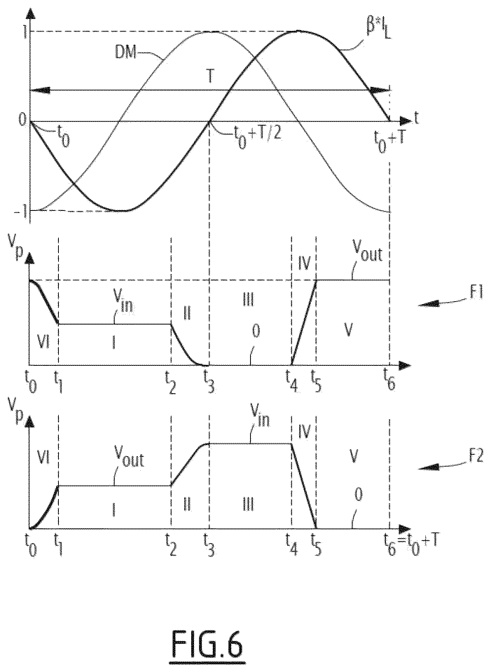

FIG. 6 shows the voltage and current curves at the terminals of the piezoelectric resonator of FIG. 1, in voltage step-up mode and in voltage step-down mode respectively, of the electrical energy converter; and

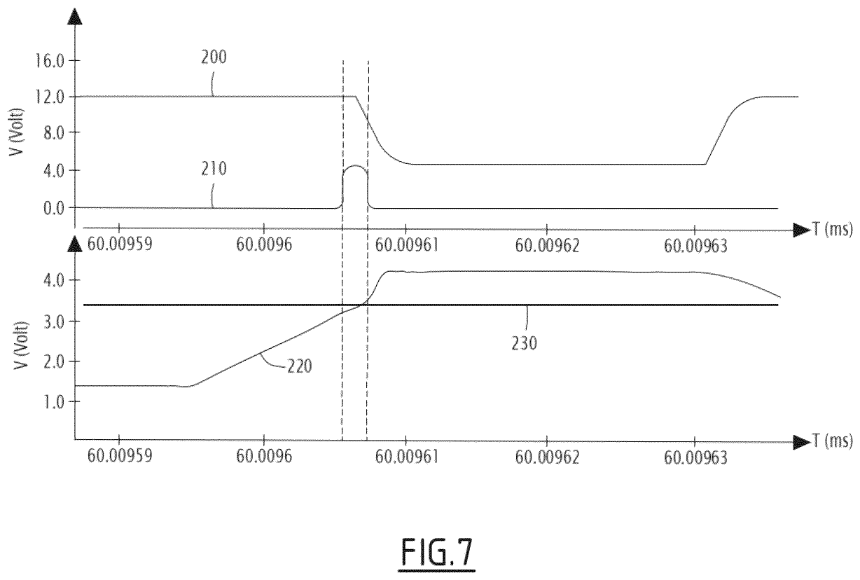

FIG. 7 shows a curve of the voltage at the terminals of the piezoelectric resonator, a curve of an order of closure of one of the switches of the electrical energy converter, a curve of an order of sampling of the voltage at the terminals of the resonator and a curve of the sampled voltage.

In FIG. 1, an electronic electrical energy conversion system 5 comprises an electrical energy converter 10 having a resonator 12 and several switches 14 connected to the resonator 12. In the example shown in FIG. 1, the resonator 12 is a piezoelectric resonator 15 and the switches 14 are labelled K1, K2 and K3. In the example shown in FIG. 2, the resonator 12 is an LLC resonator 18 and the switches 14 are denoted S1, S2, S3 and S4. In a variant not shown, the resonator 12 is a VHF type LC resonator, and the converter 10 then forms a VHF type LC resonance converter, as for example described in Vincent Massavie's thesis entitled “Convertisseur VHF intégrant des composants passifs innovants”, published in 2023 on the HAL platform.

The conversion system 5 also comprises an electronic device 20 for controlling the electrical energy converter 10.

The electronic electrical energy conversion system 5 is typically a DC electrical energy conversion system, such as a DC-DC conversion system capable of converting a first DC electrical energy input into a second DC electrical energy output, or an AC-DC conversion system capable of converting an AC electrical energy input into a DC electrical energy output from the conversion system 5. The electrical energy is typically a voltage, or alternatively a current or power.

When the electrical energy conversion system 5 is an AC/DC conversion system, the electrical energy conversion system 5 preferably also comprises a voltage rectifier, not shown, connected to the input of the electrical energy converter 10 and capable of rectifying the AC electrical voltage received at the input of the conversion system 5 in order to deliver a rectified electrical voltage to the input of the converter 10, the electrical energy converter 10 preferably being a DC/DC converter capable of converting DC electrical energy into other DC electrical energy. The voltage rectifier is for example a bridge rectifier, such as a diode bridge. Alternatively, the voltage rectifier is formed in whole or in part by switches on the converter 10, for example via bidirectional voltage switches.

The person skilled in the art will note that these various examples for the conversion system 5, whether it is a DC-DC conversion system or an AC-DC conversion system, are also presented in the documents FR 3 036 471 A1 and FR 3 086 472 A1, in particular with reference to their FIGS. 1 to 3, 10, 15, 17 and 19 to 20.

The electrical energy converter 10 is preferably a DC-DC converter, and is also called a DC-DC converter. The DC-DC converter is generally intended to regulate a supply voltage Vₒᵤₜ of a load 22 to a stable value, by being supplied by a power source 24 providing a substantially DC Vin voltage. The power source 24 is for example a battery or a solar panel.

The electrical energy converter 10 is then configured to raise the value of the DC voltage between its input and its output, and is then also called a step-up DC-DC converter, or a step-up DC-DC converter; or is configured to lower the value of the DC voltage between its input and its output, and is then called a step-down DC-DC converter, with also a step-down DC-DC converter variant.

When the electrical energy converter 10 is a step-down DC-DC converter, the value of the input voltage typically corresponds to the voltage Vᵢₙ of the energy source 24, and the value of the output voltage corresponds to the voltage Vₒᵤₜ across the load 22, the voltage Vin then being greater than the voltage Vₒᵤₜ.

When the electrical energy converter 10 is a step-up DC-DC converter, the value of the input voltage also typically corresponds to the voltage Vᵢₙ of the energy source 24, and the value of the output voltage corresponds to the voltage Vₒᵤₜ across the load 22, the voltage Vᵢₙ then being less than the voltage Vₒᵤₜ.

When the electrical energy converter 10 is a high step-down DC-DC converter, the value of the input voltage corresponds, for example, to the voltage difference (Vᵢₙ-Vₒᵤₜ), and the value of the output voltage corresponds, for example, to the voltage Vₒᵤₜ, the voltage difference (Vᵢₙ-Vₒᵤₜ) being clearly higher than the voltage Vₒᵤₜ-When the electrical energy converter 10 is a step-down DC-DC converter, according to a step-down variant, the value of the input voltage corresponds, for example, to the voltage difference (Vᵢₙ-Vₒᵤₜ), and the value of the output voltage corresponds to the voltage Vₒᵤₜ across load 22, the voltage difference (Vᵢₙ-Vₒᵤₜ) being greater than the voltage Volt.

The converter 10 comprises a number of switches 14 which can be controlled to alternate phases with substantially constant voltage and phases with substantially constant load across the resonator 12. This alternation of phases with substantially constant voltage and phases with substantially constant load is typically carried out within periods of substantially constant duration corresponding to the operating frequency of the converter 10, depending on an oscillation frequency, also called natural frequency or vibration frequency, of the resonator 12. The phases with a substantially constant load make it possible, in steady state or permanent operation, to switch from one constant voltage to another and to close the switches that must be closed when the voltage at their terminals is preferably zero, in order to have a so-called zero voltage switching mode, also called ZVS.

Each switch 14 comprises, for example, a transistor and an antiparallel diode (not shown) intrinsic to the transistor.

The transistor is, for example, an insulated gate field effect transistor, also known as a MOSFET (Metal Oxide Semiconductor Field Effect Transistor). Alternatively, the transistor is a bipolar transistor; an insulated gate bipolar transistor, also known as an IGBT (Insulated Gate Bipolar Transistor); a silicon (Si) based transistor, a GaN (Gallium Nitride) based transistor, a silicon carbide (SIC) based transistor, or a diamond based transistor, or a thyristor, or even a mechanical switch, such as a micro-switch MEMS (MicroMagnetic Magnetic Magnetic Switch).

Substantially constant load means an exchange of charge with the exterior that is less than 30% of the load that would have been exchanged with the exterior if the voltage had been kept constant. In other words, a substantially constant load means a variation in load of less than 30% of the load that would have been exchanged with the exterior of the resonator 12 if the voltage across the resonator 12 had been held constant over the time period in question.

Substantially open electrical circuit means a circuit in which any leakage current leads to a variation in the charge of the resonator 12 of less than 30% of the charge that would have been exchanged with the outside of the resonator 12 if the voltage at the terminals of the resonator 12 had been kept constant over the time period in question.

Substantially constant voltage means a voltage variation of less than 20%, preferably less than 10%, of the input or output voltage of the converter 10. By way of example, if the input voltage of the converter 10 is equal to 100V, then the voltage variation during each phase at substantially constant voltage, i.e. over each step at substantially constant voltage, is less than 20% of this voltage, i.e. less than 20V; preferably less than 10% of this voltage, i.e. less than 10V.

In the example shown in FIG. 1, the control device 20 is configured to operate the piezoelectric material of the piezoelectric resonator 15 at its resonance in order to exploit charge transfer phases that eliminate the need for an inductive element, while regulating the output voltage by maintaining the resonance of the piezoelectric material, i.e. with repeated switching cycles at an operating frequency dependent on the oscillation frequency of the piezoelectric resonator 15, and by adjusting the durations of the respective switching phases within the resonance cycle.

As known per se, the mechanical oscillation of the piezoelectric resonator 15 is approximately sinusoidal. An increase or decrease in the energy stored over a period leads to an increase or decrease in the oscillation amplitude, respectively. Furthermore, during a phase with a substantially constant load at the terminals of the piezoelectric resonator 15, i.e. when the piezoelectric resonator 15 is placed in a substantially open electrical circuit, with little exchange of electrical charges between the piezoelectric resonator 15 and the outside, an increase in the amplitude of the oscillations generates an increase in the rate of change of the voltage Vₚ at the terminals of the piezoelectric resonator 15, and during a phase with a substantially constant voltage at the terminals of the piezoelectric resonator 15, this increase in the amplitude of oscillation leads to an increase in the current exchanged between the piezoelectric resonator 15 and the exterior.

In the example shown in FIG. 1, a first switch K1 is connected between one of the input terminals and the piezoelectric resonator 15, the first switch K1 being switchable between an open position and a closed position in which the input voltage Vᵢₙ is applied across the piezoelectric resonator 15.

A second switch K2 is connected to the terminals of the piezoelectric resonator 15, the second switch K2 being switchable between an open position and a closed position in which the voltage is zero across the terminals of the piezoelectric resonator 15.

A third switch K3 is connected between one of the output terminals and the piezoelectric resonator 15, the third switch K3 being switchable between an open position and a closed position in which energy from the piezoelectric resonator 15 is restored to the output voltage Vₒᵤₜ.

The oscillation frequency is the frequency at which the resonator 12, such as the piezoelectric resonator 15, oscillates and consequently its current I_{L} on its motional branch (R-L-C branch) of its equivalent model around the selected resonance mode. The current I_{L} can be deduced either by observing the evolution of the voltage Vₚ when the resonator is isolated or by observing its output current Iₚ during phases at constant voltage. The conversion cycle is synchronised to a mechanical movement of the piezoelectric resonator 15, and the control frequency is then set to the mechanical oscillation frequency. In practice, this oscillation frequency depends on the operating point of the converter 10; Values of the three voltage steps and the output current. Depending on the operating point, this oscillation frequency typically varies between the so-called series resonance frequency of the piezoelectric (ωs=1/√(LC) where L and C correspond to the inductance and capacitance of a resonant branch 25 described below) and the so-called parallel resonance frequency of the piezoelectric (ωp=1/√(L*C*Cp/(C+Cp)), also referred to respectively as the resonant frequency and antiresonant frequency of the piezoelectric resonator 15. The operating frequency of the converter 10 then lies between these two resonance and anti-resonance frequencies of the piezoelectric resonator 15. The operating point varies slowly with respect to the oscillation frequency of the piezoelectric resonator 15. The operating point typically changes at less than 10 KHz, while the oscillation frequency of the piezoelectric resonator 15 is typically 100 KHz or more. As a result, the operating frequency of the converter 10 changes little from one period to the next.

Generally speaking, the total number of phases at substantially constant voltage during a resonance cycle is greater than or equal to one in a nominal operating mode of the converter 10.

In the example shown in FIG. 1, where the resonator 12 is the piezoelectric resonator 15, this total number of phases at substantially constant voltage is equal to three in the nominal operating mode of the converter 10. Generally speaking, when the resonator 12 is the piezoelectric resonator 15, the total number of phases at substantially constant voltage during a resonance cycle is typically greater than or equal to three.

In the example shown in FIG. 2, where the resonator 12 is the LLC resonator 18, the total number of phases at substantially constant voltage is equal to two in the nominal operating mode of the converter 10. Generally speaking, when the resonator 12 is the LLC resonator 18, the total number of phases at substantially constant voltage during a resonance cycle is typically greater than or equal to two. The two phases at substantially constant voltage typically correspond to +Vᵢₙ and −Vᵢₙ; or +Vᵢₙ/2 and −Vᵢₙ/2, where Vᵢₙ represents the input voltage to the converter 10.

When, in a variant not shown, the resonator 12 is the LC resonator of the VHF type, there is typically a single phase with a substantially constant voltage in the nominal operating mode of the converter 10, and the converter 10 then typically comprises a single switch 14.

The piezoelectric resonator 15 is known per se, and is typically modelled, close to the resonance mode used, in the form of a capacitor Cp and the resonant branch 25 connected in parallel with the capacitor Cp, the capacitor Cp and the resonant branch 25 being connected between first 26 and second 27 electrodes of the piezoelectric resonator 15. The first 26 and second 27 electrodes form the terminals of the piezoelectric resonator 15.

In the example shown in FIG. 1, the piezoelectric resonator 15 comprises a single piezoelectric element.

In a variant not shown, the piezoelectric resonator 15 comprises several piezoelectric elements connected in series. Alternatively, the piezoelectric resonator 15 comprises several piezoelectric elements connected in parallel. Alternatively, the piezoelectric resonator 15 comprises a piezoelectric element and an auxiliary capacitor connected in series. Alternatively, the piezoelectric resonator 15 comprises a piezoelectric element and an auxiliary capacitor connected in parallel. Alternatively, the piezoelectric resonator 15 comprises an arrangement of several parallel branches, each branch comprising one or more series-connected piezoelectric elements or an auxiliary capacitor.

According to the variants concerned, the auxiliary capacitor advantageously has a capacitance greater than, and preferably at least three times greater than, a reference capacitance of the piezoelectric element(s), such as the capacitance of the capacitor Cp in the example shown in FIG. 1, each piezoelectric element being modelled in the form of a capacitor and a resonant branch connected in parallel with the capacitor, the reference capacitance being the capacitance of said capacitor.

In the example shown in FIG. 1, the first switch K1 is connected between a positive input terminal and the first electrode 26 of the resonator 15, the second switch K2 is connected between the first 26 and second 27 electrodes of the piezoelectric resonator 15, and the third switch K3 is connected between the first electrode 26 of the resonator 15 and a positive output terminal and the resonator 15. By positive terminal, the person skilled in the art will understand that it is the terminal of positive polarity, i.e. which is at the highest potential of the input voltage Vᵢₙ, respectively of the output voltage Vₒᵤₜ. In the example shown in FIG. 1, the negative input and output terminals are connected to an electrical earth GND.

The resonant branch 25 is typically an RLC branch formed by an auxiliary capacitor, a resistor and an inductor connected in series (not shown). The voltage Vₚ across the piezoelectric resonator 15 then typically corresponds to the voltage across the capacitor Cp.

The capacitance of the auxiliary capacitor is advantageously greater than the capacitance of the capacitor Cp, in particular at least three times greater.

In the example shown in FIG. 2, the resonator 12 is the LLC resonator 18, and the converter 10 then forms an LLC resonant converter. The switches 14 are designated S1, S2, S3, S4.

The LLC resonant converter comprises a switching circuit 30, the LLC resonator 18 and a rectifier 32.

The switching circuit 30 is, for example, in the form of a full bridge, also known as an H-bridge, as shown in FIG. 2, or a half-bridge (not shown). The switching circuit 30 receives the input voltage Vᵢₙ.

The switching circuit 30, in its H-bridge form, comprises, for example, four transistors 34 forming the switches 14, also referred to as S1, S2, S3, S4. The transistors 34 are, for example, MOSFET transistors, such as N-type MOSFET transistors.

The LLC resonator 18 is connected to the output of the switching circuit 30, and is able to receive a voltage signal V_{cm} as input. The LLC resonator 18 comprises two inductors L and a capacitor C connected in a known arrangement to form the LLC resonator. Advantageously, the LLC resonator 18 also comprises a transformer 36, connected to the output of the LLC arrangement and capable of delivering a voltage V_{g}. The skilled person will note that the parallel inductance L at the transformer input is formed entirely or partly by the magnetising inductance of the transformer and the series inductance L is formed entirely or partly by the leakage inductance of the transformer. The skilled person will also note that the two inductances L are not necessarily identical and of the same value.

The rectifier 32 is connected to the output of the LLC resonator 18, and is therefore able to receive the voltage Vₜᵣ as input. Rectifier 32 is configured to rectify an AC voltage into the DC output voltage Vₒᵤₜ. In the example shown in FIG. 2, the rectifier 32 is in the form of a diode bridge 38, such as a four-diode bridge 38.

The control device 20 is configured to control the electrical energy converter 10, and in particular the switching of the switches 14 of the energy converter.

In the example shown in FIG. 3, the control device 20 comprises a synchronisation module 40, a measurement chain 42 and a control chain 44 for a respective switch 14.

Advantageously, the control device 20 comprises a synchronisation module 40, a measurement chain 42 and a control chain 44 for each of the respective switches 14. In other words, in the example shown in FIG. 1 where the energy converter 10 has three switches 14, the control device 20 advantageously comprises three control assemblies, namely one control assembly for each respective switch 14, each control assembly comprising a synchronisation module 40, a measurement chain 42 and a control chain 44 respectively.

More generally, the control device 20 comprises several control assemblies, and the number of control assemblies is equal to the number of switches 14 whose switching is controlled by the control device 20. The number of synchronisation modules 40, the number of measurement chains 42 and the number of control chains 44 are then each equal to the number of switches 14 controlled by the control device 20.

The synchronisation module 40, the measurement chain 42 and the control chain 44 are, for example, each in the form of an electronic circuit comprising one or more electronic components, and in particular comparators when comparisons are made.

Alternatively, the synchronisation module 40, the measurement chain 42 and the control chain 44 are each produced in the form of a programmable logic component, such as an FPGA (Field Programmable Gate Array), or in the form of an integrated circuit, such as an ASIC (Application Specific Integrated Circuit), or in the form of a computer, such as a microcontroller or processor. Alternatively, the synchronisation module 40, the measurement chain 42 and the control chain 44 are implemented together within a single hardware component, such as a single programmable logic component, a single integrated circuit or a single computer.

Advantageously, the synchronisation module 40, the measurement chain 42 and the control chain 44 are each produced using the same technology.

Advantageously, the synchronisation module 40, the measurement chain 42 and the control chain 44 are each produced on the same substrate, for example on the same silicon substrate.

The synchronisation module 40 is configured to simultaneously send an order to measure a control variable to the measurement chain 42 and an order to control a switch 14 to the control chain 44, the control order being sent more precisely to a control unit 54 for controlling a respective switch 14, the control unit 54 being included in the control chain 44.

The measurement chain 42 is configured so that, when it receives a measurement command from the synchronisation module 40, it measures a control variable for the converter 10.

The control variable is, for example, selected from the group consisting of: the voltage Vₚ, V_{cm} across the resonator 12; the voltage between one of the terminals of the resonator 12 and a reference potential, such as an electrical earth GND; the voltage across said respective switch 14; and the voltage between one of the terminals of said respective switch 14 and a reference potential, such as electrical earth GND.

The control chain 44 is configured so that, on receiving a control command from the synchronisation module 40, it controls the switching of each of the switches 14 in order to alternate phases of substantially constant voltage and phases of substantially constant load across the terminals of the said resonator 12.

A first duration D₁ of implementation of the measurement command by the measurement chain 42 is less than a second duration D₂ of implementation of the control command by the control chain 44.

The difference between the first duration D₁ and the second duration D₂ is characterised by the difference between the propagation times within the electrical or electronic elements of the measurement chain 42 and the control chain 44.

For example, the first duration D₁ is between 2 and 100 ns; and the second duration D₂ is between 1 and 99 ns. The difference (D₁-D₂) between the first duration D₁ and the second duration D₂ is typically less than 20 ns, and advantageously less than 5 ns.

The control variable is preferably measured just before the respective switch 14 is switched. For example, the control variable is measured approximately 1 ns when the respective switch 14 is switched.

The measurement chain 42 comprises two measurement probes 46, such as Kelvin probes, each present at a respective terminal of the resonator 12 and a sampling module 48 and a command unit 49 for the sampling module 48, visible in FIG. 3.

The measurement probes 46 are configured to measure a potential Vₚ⁺ at a first terminal of the resonator 12, such as the first electrode 26, and a potential Vₚ⁻ at a second terminal of the resonator 12, such as the second electrode 27, as shown in FIG. 4. Alternatively, the measurement probes 46 are configured to measure the potential difference across one of the switches.

The sampling module 48 is connected to the output of the two measurement probes 46, and is then able to receive the potentials Vₚ⁺ and Vₚ⁻ as inputs.

The sampling module 48 is able to deliver a voltage Vₛₐₘₚ, Vₛₐₘₚ corresponding to the voltage between the potentials Vₚ⁺ and Vₚ⁻, i.e. a subtraction between the sampled values of the potentials Vₚ⁺ and Vₚ⁻.

In the example shown in FIG. 3, the control chain 44 comprises a corrector 50, a generator 52 for a control signal and the control unit 54 for controlling a respective switch 14.

The control device 20 advantageously comprises a control chain 44 as shown in FIG. 3 for each switch 14 of the converter 10.

The corrector 50 is typically configured to regulate the switching control of a respective switch 14, by receiving as input the voltage Vₛₐₘₚ from the sampling module 48, calculating an error ε between this voltage Vₛₐₘₚ and a target voltage, and then integrating this error ε.

The corrector 50 comprises, for example, an operational amplifier 50A, a resistor 50B and a feedback loop with a capacitor 50C. The feedback loop connects the output of the 50A operational amplifier to its negative input. The electrical resistor 40B is connected between the input of the corrector 50 receiving the voltage Vₛₐₘₚ and the negative input of the operational amplifier 50A. This is an integrator-type corrector, but of course other types of corrector can be used, for example proportional-integral, proportional-integral-derivative.

The control signal generator 52 is connected to the output of the corrector 50, and is configured to generate control signals for the switch 14, namely a periodic control signal for opening the switch 14, and respectively a periodic control signal for closing the switch 14, as a function of the signal at the output of the corrector 50.

The control unit 54 is connected to the output of the generator 52 via the synchronisation module 40, and is then able to receive as input the opening or closing control signal from the generator 52.

The control unit 54 is connected to the input of the switch 14, the control device 20 of which is described here, and is configured to apply the control signal on opening, or respectively on closing, to a control electrode of the switch 14, such as a gate electrode when the switch 14 comprises a transistor such as a MOSFET or an IGBT.

Advantageously, the command unit 49 is configured to adjust more finely the time difference between a sampling instant tₛₐ, and a switching instant t_{com} which is later than the sampling instant tₛₐ, by adding a delay time Dₜₑₘₚ to the first duration D₁ of implementation of the measurement order by the measurement chain 42.

According to this complement, the sampling time tₛₐ then satisfies the following equation:

$${t}_{sa} = {t}_{0} + {D}_{1} + {D}_{temp} \qquad [ 1 ]$$

where tₛₐ represents the sampling time,
t₀ represents a synchronisation time between the measurement command and the control command, i.e. the time at which the synchronisation module 40 is configured to send the measurement command and the control command simultaneously,
D₁ represents the first duration of implementation of the measurement order by the measurement chain 42, and
Dₜₑₘₚ represents the delay time.

The switching time t_{com} typically satisfies the following equation:

$${t}_{com} = {t}_{0} + {D}_{2} \qquad [ 2 ]$$

where t_{com} is the switching time,
t₀ is the synchronisation time, and
D₂ represents the second duration of implementation of the control command by the control chain 44.

The delay time Dₜₑₘₚ is preferably predefined, for example by means of a prior simulation of the measurement chain 42 on the one hand, and of the control unit 54 and of the switch 14 on the other hand; and in particular by means of a prior simulation of the first duration D₁ of implementation of the measurement command by the measurement chain 42 on the one hand, and of the second duration D₂ of implementation of the control command by the control chain 44 on the other hand. The skilled person will notice that the corrector 50 and the control signal generator 52 have no impact on the second time D₂.

The delay time Dₜₑₘₚ then typically satisfies the following equation:

$${D}_{temp} = {D}_{2} - {D}_{1} - Δ \qquad [ 3 ]$$

where Dₜₑₘₚ is the delay time,
D₁ represents the first duration,
D₂ represents the second duration, and
Δ represents a target time deviation, i.e. a desired time deviation, between the sampling time tₛₐ and the switching time t_{com}.

The target time difference Δ is, for example, between 1 and 20 ns, for example substantially equal to 2 ns.

The command unit 49 is connected to the output of the synchronisation module 40, and is able to deliver two sampling signals ϕ₁ and ϕ₂, namely a first sampling signal ϕ₁ and a second sampling signal ϕ₂, to the sampling module 48, these first and second sampling signals ϕ₁, ϕ₂, being sampling stage control signals 62, 64, as described in more detail below.

As can be seen in FIG. 4, the sampling module 48 comprises a sampling unit 58 and a differential unit 60.

The sampling unit 58 is connected to the two measurement probes 46 and to the command unit 49, and is then able to receive as input the voltages Vₚ⁺ and Vₚ⁻, as well as the sampling signals ϕ₁ and ϕ₂.

The sampling unit 58 comprises a first sampling stage 62 and a second sampling stage 64.

The first sampling stage 62 is connected to the two measurement probes 46 to receive the input voltages Vₚ⁺ and Vₚ⁻, and to the command unit 49 to receive the first sampling signal ¢, forming a control signal for the first sampling stage 62.

The first sampling stage 62 is configured to sample the voltages Vₚ⁺ et Vₚ⁻ over a very short period of time, for example a nanosecond.

The first sampling stage 62 comprises, for example, four transistors M1, M2, M3 and M4, two inversion logic gates 66 and two capacitors C1 and C2.

Transistors M1 and M2 are connected on the input side to a first measurement probe 46, and can receive the voltage Vₚ⁺ on the input side.

The first sampling signal ϕ₁ is applied directly to the control electrode of transistor M1, and is applied to the control electrode of transistor M2 via the inversion logic gate 66.

Transistors M1 and M2 are connected to capacitor C1 via their first conduction electrodes. Transistors M1 and M2 are configured so that, when they are in the closed position, they enable the capacitor C1 to be charged.

Transistors M3 and M4 are connected on the input side to a second measurement probe 46, and can receive the voltage Vₚ⁺ on the input side.

The first sampling signal ϕ₁ is applied directly to the control electrode of transistor M3, and is applied to the control electrode of transistor M4 via the inversion logic gate 66.

Transistors M3 and M4 are connected to capacitor C2 via their first conduction electrodes. Transistors M3 and M4 are configured so that, when they are in the closed position, they enable capacitor C2 to be charged.

In the example shown in FIG. 4, transistors M1 and M3 are N-type insulated gate field effect transistors (more commonly known as MOSFETs); transistors M2 and M4 are P-type insulated gate field effect transistors (more commonly known as MOSFETs), which explains the use of inversion logic gates 66 to control transistors M2 and M4.

The first sampling stage 58 is able to supply a voltage V_{C1} across the capacitor C1 and a voltage V_{C2} across the capacitor C2.

The second sampling stage 64 is connected to the output of the first sampling stage 62, and is therefore able to receive the voltages V_{c1} and V_{c2}.

The second sampling stage 64 is configured to sample the output voltages of the first sampling stage 62 over a longer period of time, for example ten nanoseconds.

The second sampling stage 64 comprises, for example, four transistors M5, M6, M7 and M8, two inversion logic gates 66 and two capacitors C3 and C4.

Transistors M5 and M6 are connected on the input side to capacitor C1 and are therefore able to receive the voltage V_{c1} on the input side.

The second sampling signal ϕ₂ is applied directly to the control electrode of M5, and is applied to the control electrode of M6 via the inversion logic gate 66.

Transistors M5 and M6 are connected to capacitor C3 via their first conduction electrodes. Transistors M5 and M6 are configured so that, when they are in the closed position, they enable capacitor C3 to be charged.

Transistors M7 and M8 are connected on the input side to capacitor C2, which is then able to receive the voltage V_{C2} on the input side.

The second sampling signal ϕ₂ is applied directly to the control electrode of M7, and is applied to the control electrode of M8 via the inversion logic gate 66.

Transistors M7 and M8 are connected to capacitor C4 via their first conduction electrodes. Transistors M7 and M8 are configured so that when they are in the closed position, they enable capacitor C4 to be charged.

The second sampling stage 64 is able to supply a voltage Vₛₐₘₚ₁ across capacitor C3 and a voltage Vₛₐₘₚ₂ across capacitor C4.

In the example shown in FIG. 4, transistors M5 and M7 are N-type insulated gate field effect transistors (more commonly known as MOSFETs); transistors M6 and M8 are P-type insulated gate field effect transistors (more commonly known as MOSFETs). transistors (more commonly known as P-type MOSFETs), which explains the use of inversion 66 logic gates to control transistors M6 and M8.

The ratio between the sampling signal ϕ₁ and the sampling signal ¢2 is preferably greater than 10, even more preferably greater than 15, and even more preferably substantially equal to 20.

The differential unit 60 is connected to the output of the second sampling stage 64 and is then able to receive the input voltages Vₛₐₘₚ₁ and Vₛₐₘₚ₂.

The differential unit 60 is designed to deliver a voltage Vₛₐₘₚ resulting from the difference between the voltages Vₛₐₘₚ; and Vₛₐₘₚ₂.

The differential unit 60 comprises, for example, an operational amplifier 68, three electrical resistors 70 and a feedback loop with another electrical resistor 70. The feedback loop connects the output of the operational amplifier 68 to its negative input. A first of the three resistors 70 is connected between the voltage Vₛₐₘₚ₁ and the negative input of the operational amplifier. A second of the three resistors 70 is connected between the voltage Vₛₐₘₚ₂ and the positive input of the operational amplifier 68. A third of the three resistors 70 is connected between the potential V_{mc} of the circuit and the positive input of the operational amplifier 68.

Advantageously, the values of the resistors 70 are all substantially equal so that Vₛₐₘₚ is equal to Vₛₐₘₚ₁-Vₛₐₘₚ₂.

The first sampling signal_{ϕ1}, for example with a duration of approximately 1 ns, then activates four transistors M1, M2, M3 and M4, charging the two sampling capacitors C1 and C2 with the voltage values Vₚ₊ and Vₚ₋. Irrespective of the error measured, sampling is always carried out before the corresponding switch 14 is switched. For example, the first sampling signal ϕ₁ is generated by the command unit 49 a few nanoseconds (>2 ns) before the corresponding switch 14 is switched, i.e. a few nanoseconds, for example substantially 2 ns, before the switching instant t_{com}.

The second sampling signal ϕ₂ is delayed relative to the first sampling signal ϕ₁, for example by about 20 ns, and has a longer active duration than the first sampling signal ϕ₁, for example of a duration substantially equal to 10 ns, with a rise/fall time greater than that of the first sampling signal ϕ₁, in order to reduce variations due to the load injected into the sampled voltages Vₛₐₘₚ₁ and Vₛₐₘₚ₂. The sampled signals are then subtracted using the differential unit 60, for example the operational amplifier 68 in subtractor configuration, with a gain of 1. This circuit also adds a common mode V_{mc} to the voltage Vₛₐₘₚ.

The first sampling stage 62 must sample over a very short time (1 ns for example), which means that transistors M1 to M4 must be large enough to charge capacitors C1, C2 over such a short time. Controlling these transistors M1 to M4 requires a large amount of charge to be applied to/withdrawn from their control electrode. The injection/withdrawal of this large charge disturbs the source potential of these transistors and therefore the voltage across capacitors C1 and C2, i.e. a first disturbance in one direction on closing, then a second disturbance in the other direction on opening. This would be detrimental to the second sampling stage 64 and the differential unit 60, which would be noisy; however, the first and second disturbances compensate for each other (disturbance in one direction, then in the other) and the voltage across the capacitors C1, C2 is stable over the rest of the period.

The second sampling stage 64 then samples the voltage across capacitors C1, C2 over a stable voltage time range. This second sampling is much less constrained and can be carried out over a much longer period, such as 10 ns, which allows the use of much smaller transistors M5 to M8 that require much less charge to be controlled, charge that has little or no effect on the voltage across capacitors C3 and C4. The differential unit 60 at the output of capacitors C3 and C4 is then disturbed little or not at all.

The nominal operation of a cycle of the converter 10 comprising a piezoelectric resonator 15 will now be described with reference to FIG. 6 showing the successive phases of a resonance cycle of the piezoelectric resonator, according to a generic format corresponding to different operating modes of the converter 10, namely a first operating mode F1, also called voltage boosting mode; and a second operating mode F2, also called voltage reduction mode.

FIG. 6 then shows the evolution of the current β*I_{L} of the amplitude-normalised current I_{L} flowing in the piezoelectric resonator 15 visible in FIG. 1; of the voltage Vₚ across the piezoelectric resonator 15; and of the mechanical deformation of the piezoelectric resonator 15, represented by the DM curve; all this during a resonance cycle and for two operating modes of the converter 10, namely the first operating mode F1 as a voltagestep-up converter, and the second operating mode F2 as a voltage reducer. With β=−1 in step-up operating mode F1; and β=+1 in step-down operating mode F2.

By convention, a first switching time instant, denoted t₁, corresponds to the closing of the first switch K; for the first F1 mode, or the third switch K₃ for the second mode F2, and the voltage Vₚ across the piezoelectric resonator 15 is then substantially constant and equal to the input voltage Vᵢₙ according to the first mode F1, or to the output voltage Vₒᵤₜ according to the second mode F2. At this first switching time instant t₁, a first phase I begins, lasting until the switch closed at the first switching time instant t₁ is opened.

A second switching time instant, noted t₂, corresponds to the opening of the first switch K₁ for the first mode F1, respectively of the third switch K₃ for the secondmode F2, and the voltage Vₚ at the terminals of the piezoelectric resonator 15 then changes from a previous voltage Vᵢₙ according to the first mode F1, or Vₒᵤₜ according to the second mode F2, to an open circuit position. At this second switching time instant t₂ a second phase II then begins, lasting until a time instant t₃ corresponding to a zero crossing of the current I_{L} flowing in the piezoelectric resonator 15. Beforehand, the time instant t₂ has been defined so that at the time instant t₃, the voltage Vₚ across the terminals of the piezoelectric resonator 15 reaches a value corresponding to the value enabling the corresponding switch to be switched to zero voltage.

At the time instant t₃, a third phase III begins, with the voltage substantially constant at the zero value according to the first mode F1 via closure of the second switch K2, or the input voltage Vᵢₙ in the second mode F2 by closing the first switch K₁, and lasts until a time instant t₄ which forms a setting parameter of the converter 10, this time instant t₄ to define the desired voltage, current or power output from the converter 10.

The time instant t₄ corresponds to the end of the third phase III and to the instant at which the second switch K₂ according to the first mode F1, or respectively the first switch K₁ according to the second mode F2, must then be opened, the time instant t₄ forming a fourth switching time instant corresponding to the opening of the second switch K₂ according to the first mode F1, or respectively of the first switch K₁ according to the second mode F2.

At the fourth switching time instant, a fourth phase IV begins, corresponding to a phase with a substantially constant load, or a substantially open circuit, this fourth phase IV lasting until a time instant t₅ defined by the change to a new predefined value of the voltage Vₚ across the piezoelectric resonator 15. When the converter 10 comprises three switches K₁, K₂, K₃ capable of being controlled to alternate phases with substantially constant voltage and phases with substantially constant load at the terminals of the piezoelectric resonator 15, the time instant t₅ forming the end of the fourth phase IV typically corresponds to the closing of the third switch K₃ according to the first mode F1, or respectively of the second switch K2 according to the second mode F2, the time instant t₅ then forming a fifth switching time instant.

At time instant t₅, a fifth phase V begins, corresponding to a phase with a substantially constant voltage at the output voltage Vₒᵤₜ according to the first mode F1 by closing the third switch K3, or at zero value according to the second mode F2 by closing the second switch K2. This fifth phase V lasts until a time instant t₀, or until a time instant t₆ modulo the period T of the resonance cycle defined by the zero crossing of the current I_{L} flowing in the piezoelectric resonator 15, and according to a monotonicity opposite to that of the zero crossing at time instant t₃. By convention, the time instant t₆ is equal to the sum of the time instant t₀ and the period T of the resonance cycle, and is also denoted (t₀+T).

In the example shown in FIG. 6, the time instant to corresponds to the end of a resonance cycle of the piezoelectric resonator 15, the cycle shown having been defined with respect to the time instants of zero crossing of the current I_{L} flowing in the piezoelectric resonator 15, and not with respect to the first switching time instant t₁.

The time instant t₀, or the time instant t₆, is obtained by opening the third switch K₃ according to the first mode F1, or respectively the second switch K2 according to the second mode F2, and then forms a sixth switching time.

From the zero crossing of the current I_{L} flowing in the piezoelectric resonator 15, a sixth phase VI corresponding to a phase with a substantially constant load then begins, this sixth phase VI phase flowing between the time instant to and the time instant t₆+t₁, or between the time instant t₀ and the time instant t₁ in the example of FIG. 6, it being understood that the time instant t₆ corresponds to the time instant to t₀ within one resonance cycle. The end of this sixth phase VI corresponds to the moment when the voltage Vₚ across the piezoelectric resonator 15 terminals reaches the input voltage Vᵢₙ according to the first mode F1, or the output voltage Vₒᵤₜ according to the second mode F2.

The method for controlling an electrical energy converter 10 via the control device 20 will now be described with reference to the flowchart in FIG. 5, the method comprising three distinct stages.

The following method is advantageously implemented before each substantially constant voltage stage, i.e. before each substantially constant voltage phase, and for the respective switch 14 associated with that substantially constant voltage stage, as explained above.

In the first step 100, the synchronisation module 40 simultaneously sends a command to measure the control variable to the measurement chain 42 and a command to control the respective switch 14 to the control chain 44.

In the second step 110, after receiving the measurement command from the synchronisation module 40, the measurement chain 42 measures the control variable of the converter 10. The control variable is then measured at the sampling time tₛₐ.

The control variable of the converter 10 is typically selected from the group consisting of: the voltage across the resonator 12; the voltage between one of the terminals of the resonator 12 and a reference potential, such as an electrical earth; the voltage across said respective switch 14; the voltage between one of the terminals of said respective switch 14 and a reference potential, such as electrical earth.

In the third step 120, after receiving the control command from the synchronisation module 40, the control chain 44 controls the respective switch 14. Control of switch 14 is then effective at switching time t_{com}

Advantageously, the command unit 49 adjusts more finely the time difference between the sampling instant tₛₐ and the switching instant t_{com} subsequent to the sampling instant tₛₐ, by adding the time delay duration Dₜₑₘₚ to the first duration D₁ of implementation of the measurement order by the measurement chain 42.

The switching time t_{com} then occurs just after the sampling time tₛₐ, the target time difference Δ, i.e. the desired time difference between the sampling time tₛₐ and the switching time t_{com} is advantageously between 0.5 and 20 ns, for example substantially equal to 2 ns.

Control of the converter 10 is therefore more precise, as it is carried out during the subsequent step at a substantially constant voltage on the basis of the value of the control variable measured just before the start of this step.

FIG. 7 shows a curve 200 of the control command received by the respective switch 14 (in the example 12V corresponds to an open command and 5V to a close command), a curve 210 of the sampling signal forming the measurement command of the control variable, a curve 220 of the voltage Vₚ across the resonator 12, and a curve 230 of the measured value of the control variable. In the example shown in FIG. 7, the control variable is the voltage Vₚ across the resonator 12.

The skilled person will then observe that the sampling command occurs immediately before the respective switch 14 is closed, the measured quantity visible on curve 230 is then equal to the value of the voltage Vₚ across the resonator 12 just before the respective switch 14 is closed.

It is therefore conceivable that the electronic control device 20 and the control method according to the invention enable better control with more accurate measurement of the control variable just before at least one moment of closure of a respective switch 14, and preferably before each moment of switch 14 closure. This improved regulation then enables improved control of the electrical energy converter 10.

Advantageously, the values of the control variable are measured systematically and periodically before the successive closing instants of the switches 14, i.e. before each start of the phase at substantially constant voltage.

1. An electronic device for controlling an electrical energy converter capable of converting an input voltage into an output voltage, the converter comprising two input terminals for receiving the input voltage, two output terminals for delivering the output voltage, a resonator, and several switches connected to the resonator,
the electronic control device comprising:
a measurement chain configured to measure a control variable of the converter;
a control chain configured to control switching of each of the switches, to alternate phases of substantially constant voltage across the resonator and phases of substantially constant load across said resonator,
the control chain comprising a control loop configured to control a switching time of a respective switch on the basis of the measured control variable;
a synchronisation module configured to simultaneously send a command to measure the control variable to the measurement chain and a command to control the respective switch to the control chain, and
the time taken for the measurement command to be implemented by the measurement chain is less than the time taken for the control command to be implemented by the control chain, so that the control variable is measured before the respective switch is switched.

2. The device according to claim 1, wherein the respective switch is selected from the group comprising:
one of the switches, referred to as the first switch, connected between one of the input terminals and the resonator, the first switch being switchable between an open position and a closed position in which the input voltage is applied to the terminals of the resonator;
one of the switches, referred to as the second switch, connected between one of the input terminals and the resonator, the second switch being switchable between an open position and a closed position in which the voltage is zero across the resonator;
one of the switches, referred to as the third switch, connected between one of the output terminals and the resonator, the third switch being switchable between an open position and a closed position in which energy from the resonator is restored to the output voltage.

3. The device according to claim 1, wherein the control variable is selected from the group consisting of: the voltage across the resonator; the voltage between one of the terminals of the resonator and a reference potential, such as electrical earth; the voltage across said respective switch; and the voltage between one of the terminals of said respective switch and a reference potential, such as electrical earth.

4. The device according to claim 3, wherein the measurement chain comprises two measurement probes adapted to measure the two end potentials of the voltage forming the control variable, each measurement probe being adapted to measure a respective potential at a respective end of said voltage.

5. The device according to claim 4, wherein the voltage forming the control variable is then obtained by the difference between the two end potentials measured respectively by the two measurement probes.

6. The device according to claim 4, wherein the measurement chain comprises a sampling module connected to the two measurement probes; the sampling module comprising a first stage connected to the two measurement probes, a second stage connected to the output of the first stage and a differential unit connected to the output of the second stage; the first stage being configured to generate a first sampling pulse, and the second stage being configured to generate a second sampling pulse after the first sampling pulse; the second sampling pulse having a longer duration than the first sampling pulse.

7. The device according to claim 6, wherein a ratio between the duration of the second sampling pulse and that of the first sampling pulse is greater than 10.

8. The device according to claim 6, wherein the first stage includes a pair of first sampling capacitors and a pair of first switches, each first switch each first switch being connected between a respective measurement probe and first capacitor and configured, when switched to the closed position, to enable charging of the respective first capacitor.

9. The device according to claim 6, wherein the second stage includes a pair of second sampling capacitors and a pair of second switches, each second switch being connected to a respective second capacitor and configured, when switched to the closed position, to enable charging of the respective second capacitor.

10. The device according to claim 1, wherein when the converter operates at an operating frequency greater than 1 MHz, the control variable is measured between 0.5 ns and 20 ns, advantageously substantially 1 ns, before the respective switch is switched.

11. The device according to claim 1, wherein the resonator is a piezoelectric resonator.

12. The device according to claim 11, wherein the piezoelectric resonator consists of one of the constitutions among the group consisting of: a single piezoelectric element; a plurality of piezoelectric elements connected in series; several piezoelectric elements connected in parallel; a piezoelectric element and an auxiliary capacitor connected in series; a piezoelectric element and an auxiliary capacitor connected in parallel; and an arrangement of several parallel branches, each branch comprising one or more piezoelectric elements connected in series or an auxiliary capacitor.

13. The device according to claim 12, wherein the auxiliary capacitor has a capacitance greater than a reference capacitance of the piezoelectric element(s), each piezoelectric element being modelled as a capacitor and a resonant branch connected in parallel to the capacitor, the reference capacitance being the capacitance of said capacitor.

14. The device according to claim 1, wherein the resonator is an LC resonator comprising an inductor and a capacitor connected in series with the inductor.

15. The device according to claim 1, wherein the simultaneous sending of a command to measure the regulation variable to the measurement chain and of a command to control the respective switch to the control chain is carried out for several switch controls during the same resonance cycle of the resonator; the duration of implementation of the measurement command by the measurement chain being less than the duration of implementation of the control command by the control chain, so that the control variable is measured before the switching of the respective switch, for these several switch commands during the same resonance cycle.

16. The device according to claim 15, wherein these several switch controls during the same resonance cycle are switch closures forming phase starts with substantially constant voltage at the terminals of the resonator.

17. The device according to claim 15, wherein the control device comprises several control assemblies, and the number of control assemblies is equal to the number of switches whose switching is controlled by the control device, each control assembly comprising a respective synchronisation module, measurement chain and control chain.

18. An electrical energy conversion system comprising:
an electrical energy converter capable of converting an input voltage into an output voltage, the converter having two input terminals for receiving the input voltage, two output terminals for supplying the output voltage, a resonator, and several switches connected to the resonator; and
an electronic control device for controlling the electrical energy converter; the control device being according to claim 1.

19. A method for controlling an electrical energy converter capable of converting an input voltage into an output voltage, the converter comprising two input terminals for receiving the input voltage, two output terminals for delivering the output voltage, a resonator, and several switches connected to the resonator,
the method being implemented by an electronic control device and comprising:
measurement, via a measurement chain, of a variable controlling the converter;
control, via a control chain, of a switching of each of the switches, to alternate phases with substantially constant voltage across the resonator and phases with substantially constant load across said resonator,
the control chain comprising a control loop configured to control a switching time of a respective switch on the basis of the measured control variable; and
further, prior to the measurement and control:
a synchronisation step comprising simultaneously sending a command to measure the control variable to the measurement chain and a command to control the respective switch to the control chain, and
the time taken for the measurement command to be implemented by the measurement chain being less than the time taken for the control command to be implemented by the control chain, so that the control variable is measured before the respective switch is switched.
